(19) United States
(12) Patent Application Publication
(10) Pub. No.: US 2003/0128969 A1
(43) Pub. Date: Jul. 10, 2003

(54) Personal video recorder and method for operating the same

(76) Inventor: Sang Hyup Lee, Seoul (KR)

Correspondence Address: BIRCH STEWART KOLASCH & BIRCH, PO BOX 747, FALLS CHURCH, VA, 22040-0747, US

(21) Appl. No.: 10/338,745

(22) Filed: Jan. 9, 2003

(30) Foreign Application Priority Data
Jan. 9, 2002 (KR) 01254/2002

(51) Int. Cl. H04N 5/781

(52) U.S. Cl. 386/111; 386/125

(57) ABSTRACT

A personal video recorder (hereinafter, as PVR), including a decoder unit for parsing a transport packet (hereinafter, as TP) stream into a video stream and an audio stream by receiving the TP stream, decoding and outputting the parsed video stream and audio stream, an image processing unit for capturing and outputting a representative image from the video signal which was decoded from the decoder unit and a storage unit for storing a TP stream which was not parsed but was bypassed in the decoder unit or storing a representative image outputted from the image processing unit and a method for operating the same. By the above recorder and method, the user can visually grasp the contents of the broadcasting program immediately without watching the whole program using the function of the story board which includes the representative image and detailed information and conveniently enjoy various functions of the PVR.

### BACKGROUND OF THE INVENTION

1. Field of the Invention

The present invention relates to a personal video recorder and a method for operating the same and particularly, to a personal video recorder, capable of supporting a story board so that a user can immediately grasp the content of a program recorded in a personal video recorder visually, and a method for operating the same.

2. Description of the Related Art

Recently, as digital technology is developed, analog broadcasting has been actively digitalized in all countries of the world. As the broadcasting system is converted to a digital system, the number of channels was increased and the quality of products was improved. In response, a digital TV can be advantageously developed to various application products as well as simple TV sets. As the application product of the digital system, there are web TVs, personal video recorders (PVR) and the like.

A personal video recorder (hereinafter, as PVR) which is also called as a digital video recorder is a product which records and regenerates a program which is currently on air into a digital system at real time by mounting a storage apparatus such as a hard disk. That is, the PVR stores audio and video information in a digital system differently from conventional analog VCR tapes by mounting a hard disk drive, and ensures good image quality, clearer sound without loss of information even if unlimited recording and regeneration are performed.

The core function of the PVR is a time shift function which enables simultaneous recording and regeneration of a broadcasting which is currently watched by a viewer.

For instance, by the time shift function of the PVR, in case there is a telephone call when the viewer is watching the current broadcasting program, when the viewer pushes a pause button of a remote controller, the broadcasting streams which are received thereafter are recorded in the hard disk, and after the telephone call is over, when the viewer pushes a play button, it is possible that the viewer can watch from the paused screen which is recorded in the hard disk. That is, the time shift function enables simultaneous recording and regeneration at a predetermined time interval continuously.

As another functions of the PVR, there are recording functions similar as those of the conventional VCR, or there are regeneration, fast winding, rewinding and slow motion and the like of the broadcasting program which is currently buffered. Also, using an instant replay function, a scene which a viewer wants to view again can be repeatedly watched.

FIG. 1 is a block diagram showing the operation of the general PVR.

As shown in FIG. 1, basically, the PVR has a structure adding a hard disk driver 40 to a digital TV module.

The digital TV module 1 includes a tuner 20 for outputting a transport packet stream (hereinafter, as TP) of a broadcasting channel selected by the user by receiving a sky wave signal inputted from an antenna 10, and a decoder 30 for dividing the TP stream into video and audio streams by receiving the signal and decoding the streams.

The various functions of the PVR can be divided into decoding and regenerating the broadcasting stream received from the sky wave at real time, and recording the broadcasting stream, and regenerating the stored broadcasting stream.

FIG. 2 is a block diagram showing the operation of a general PVR.

The operation will be described in more detail with reference to FIGS. 1 and 2.

Firstly, by the function of decoding and regenerating the broadcasting stream received from the sky wave at real time, the TP stream of broadcasting channel selected by the user, which is outputted from the tuner 20 is parsed in the transport packet decoder 31 of a decoder 30 and is divided into video and audio stream, and the separated video and audio streams are decoded in the video IS decoder 35 and audio decoder 37, and are outputted to the display 50 and speaker 60, thus to regenerate video and audio.

Also, by the function of recording the broadcasting stream of the PVR, when the TP stream outputted from the tuner 20 is recorded, the TP stream which was not parsed to the video and audio streams in the TP decoder 31 of the decoder 30 is bypassed and stored in the hard disk drive 40.

Finally, by the function regenerating the stored broadcasting stream, to regenerate the TP stream stored in the hard disk drive 40, the TP decoder 31 of the decoder 30 reads the TP stream stored in the hard disk drive 40, and divides the TP stream into video and audio streams by parsing the TP stream into the video and audio streams. The divided video and audio streams are decoded in the video decoder 35 and audio decoder 37, and are outputted to the displayer 50 and speaker 60, thus to regenerate video and audio.

The elements of the decoder 30 and the hard disk drive 40 perform recording and regeneration by control of the control unit 33.

The above PVR performs recording and regeneration of programs using the functions of regeneration, fast winding, rewinding, slow motion, instant replay and the like. However, in this case the viewer cannot grasp the contents of the recorded program at once, that is, the user must repeatedly perform searching and regenerating operations to move a scene which a viewer wants to view again. Therefore, the conventional PVR does not show differences of functions from the analog video recorder and accordingly, with the conventional video recorder, the user could not take advantage of the digital broadcasting.

### SUMMARY OF THE INVENTION

Therefore, an object of the present invention is to provide a personal video recorder (hereinafter, as PVR), capable of supporting a story board so that a user can visually recognize the contents of the program recorded in the PVR, recording and regenerating the broadcasting program in a format of the story board in which a representative image and detailed information are included, and a method for operating the same.

To achieve these and other advantages and in accordance with the purpose of the present invention, as embodied and broadly described herein, there is provided a PVR, including a decoder unit for parsing a transport packet stream into a video stream and an audio stream by receiving the transport packet stream, decoding and outputting the parsed video stream and audio stream, an image processing unit for capturing and outputting a representative image from the video signal which was decoded from the decoder unit and a storage unit for storing a transport packet stream which was not parsed but was bypassed in the decoder unit or storing a representative image outputted from the image processing unit.

To achieve these and other advantages and in accordance with the purpose of the present invention, as embodied and broadly described herein, there is provided a method for operating the PVR, including storing a transport stream of the broadcasting channel selected by a user, recording for generating and storing a representative image after decoding the transport packet stream and regeneration for outputting an video or a representative image by receiving the stored transport packet stream and the stored representative image.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram showing an operation of a general personal video recorder;

FIG. 2 is a block diagram showing the operation of a general PVR;

FIG. 3 is a block diagram of a PVR in accordance with the present invention;

FIG. 4 is an exemplary view showing a story board which displays just a representative screen of a broadcasting program in accordance with the present invention;

FIG. 5 is an exemplary view showing the story board in which the representative screen and detailed information are included in accordance with the present invention; and

FIG. 6 is an exemplary view showing the story board in which the representative screen and detailed information of a plurality of broadcasting programs are included in accordance with the present invention.

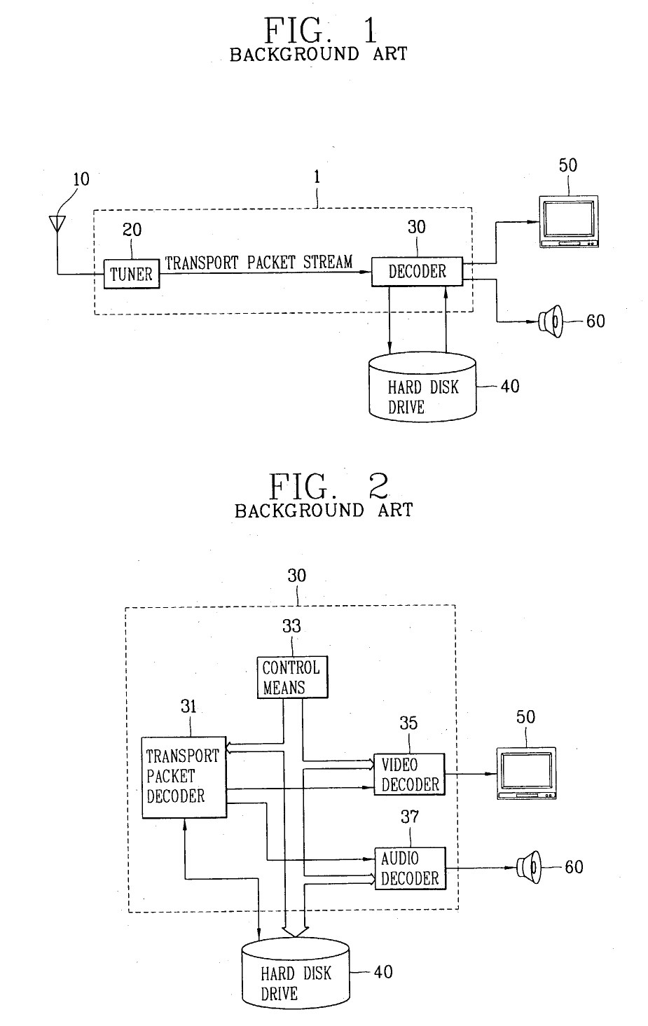

### DETAILED DESCRIPTION OF THE PREFERRED EMBODIMENTS

Reference will now be made in detail to the preferred embodiments of the present invention, examples of which are illustrated in the accompanying drawings.

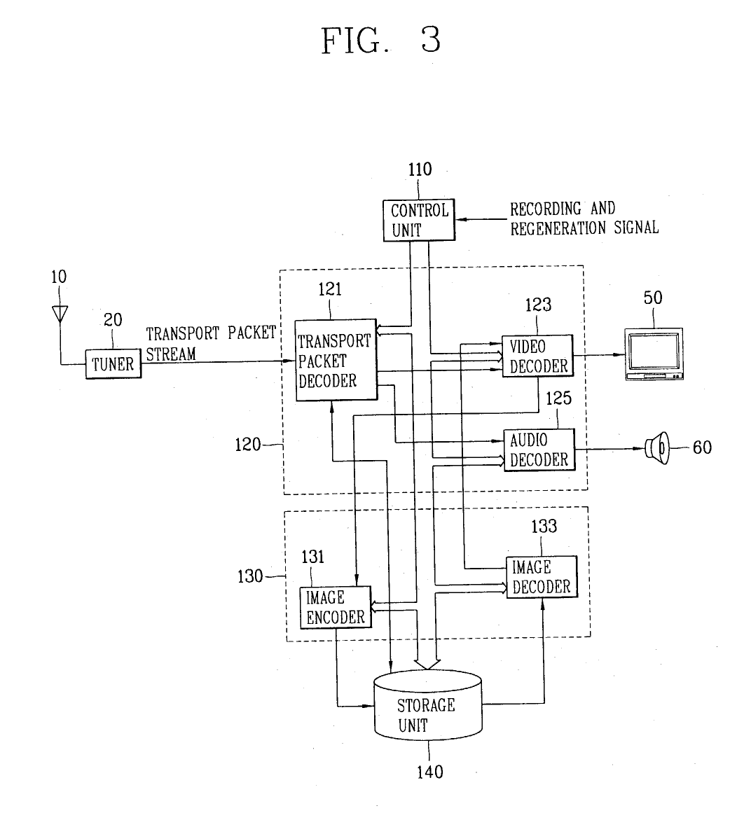

FIG. 3 is a block diagram of a PVR in accordance with the present invention.

As shown in FIG. 3, the PVR includes a tuner 20 which receives the broadcasting signal from an antenna 10 and outputs the signal as a transport packet (hereinafter, as TP) stream selected by the user, a decoder unit 120 for parsing a TP stream into a video stream and an audio stream by receiving the TP stream, decoding and outputting the parsed video stream and audio stream, an image processing unit 130 for capturing and outputting a representative image from the video signal which was decoded from the decoder unit 120, a storage unit 140 for storing a TP stream which was not parsed but was bypassed in the decoder unit or storing a representative image outputted from the image processing unit 130, and a control unit 110 for controlling the decoder unit 120, the image processing unit 130 and the storage unit 140.

Here, the decoder unit 120 includes a transport packet decoder 121 for parsing the TP stream of a broadcasting channel selected by a user into a video stream and an audio stream by receiving the TP stream, an video decoder 123 for outputting the video signal in a displayer by decoding after receiving the video stream which was parsed from the TP decoder 121, and a audio decoder 125 for outputting the audio signal in a speaker by decoding after receiving the audio stream which was parsed from the TP decoder.

The storage unit 140 can implement a storage apparatus such as a hard disk drive and a memory chip.

Also, the image processing unit 130 includes an image encoder 131 for capturing a representative image by receiving the decoded video signal which was outputted from the video decoder 123, and storing the image in the storage unit 140 by encoding to a compression image, and an image decoder 133 for decompression by receiving the compression image stored in the storage unit 140, and outputting the decompressed image to the video decoder 123.

The operation of the video recorder in accordance with the present invention with the above construction will be described as follows.

Firstly, when the user transports a control signal for recording a specific broadcasting program with a wireless terminal such as a remote controller, the tuner 20 selects the TP stream of the specific broadcasting program from the sky wave received from through the antenna 10 and outputs the stream. The TP stream which was outputted from the tuner 20 is parsed and divided into video and audio streams in the TP decoder 121, and at the same time, a TP stream which was not parsed but bypassed in the TP decoder 121 is stored in the storage unit 140.

The video stream which was decoded in the TP decoder 121 is decoded in the video decoder 123, and the decoded video signal is outputted to the displayer 50. At this time, the image encoder 131 captures images for composing the representative screen of the broadcasting program by receiving the decoded video signal, and compresses the captured image.

Here, at least one representative images can be generated in each specific time period for one broadcasting program, and the images are stored in the storage unit 140. For instance, generating the representative image is generated by ad hoc method which is selected by a specific time period, or by a specific algorithm which selects the representative image when changes of a scene, background and characters are occurred.

The method for generating the representative image will be described in more detail.

If a TP stream of an a broadcasting program is stored in the storage unit 140 in a format of a.tp, the representative images corresponding to a is stored in a format of a.img. At this time, the image encoder 131 does not need to encode all image screens. That is, the image encoder selectively encodes just screens that can represent the program at a predetermined time interval. For instance, when the control unit 110 sets to generate the representative image in unit of 5 minutes, the image processing unit 130 generates 12 representative screens by encoding in case the program has a show time of an hour. At this time, the compressed image has file formats of compressed images such as jpeg, gif and the like. The reason that the image is compressed is to reduce the bit rate transported in case of storing the image in the storage unit 140 since the bandwidth of a bus which is connected with the storage unit 140 is not sufficient. However, the representative image can be used in the present invention without compressing it.

Finally, after completing recording the broadcasting program, in case the user regenerates the program in the displayer, the regeneration signals are outputted to the control unit 110 using the wireless terminal such as a remote controller. The control unit 110 applies a control signal in the storage unit 140 by receiving the regeneration control signal. Then, the storage unit 140 receives the control signal of the control unit 110 and outputs the compressed image corresponding to the representative screen of the broadcasting program to the image decoder 133. The image decoder 133 performs decompression of the compressed image, and outputs the image to the displayer 50 through the video decoder 123.

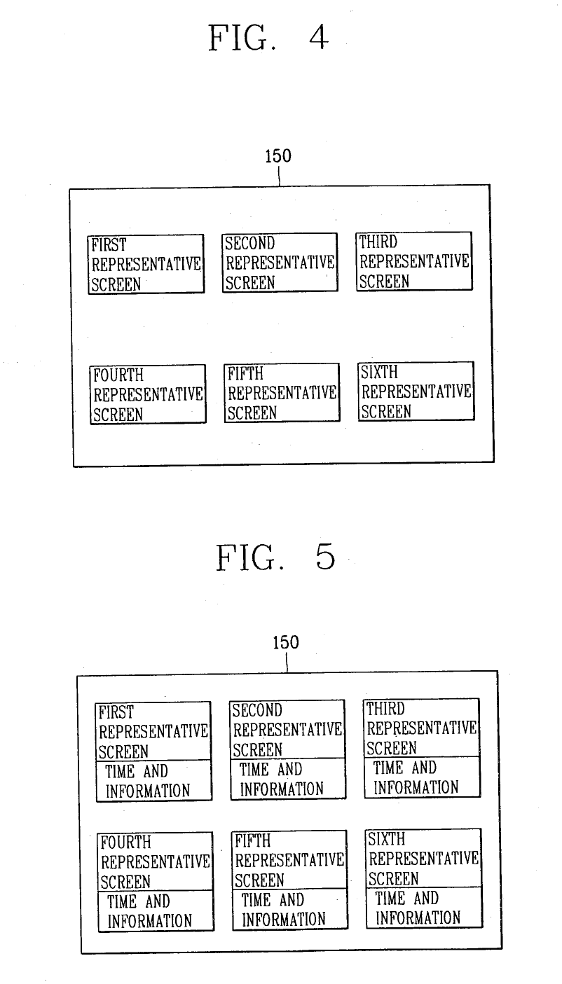

FIG. 4 is an exemplary view showing a story board which displays the representative screen of the broadcasting program in accordance with the present invention.

As shown in FIG. 4, in the story board, images corresponding to the representative screen of the broadcasting programs are aligned. That is, a basic story board comprising first to sixth representative screens is displayed for the user.

Also, the PVR in accordance with the present invention can manufacture a story board 100 composed of detailed information of the recorded broadcasting programs and representative screens.

FIG. 5 is an exemplary view showing the story board in which the representative screen and detailed information are included in accordance with the present invention.

As shown in FIG. 5, in the story board 100, images of the representative screen are generated at a predetermined time interval for a recorded broadcasting program, and the images are the representative screens of the broadcasting program and are aligned as the first to sixth representative screens. Here, the detailed information of the broadcasting program means time and information of FIG. 5, and the information is related to the broadcasting program, such as the contents of the broadcasting program, characters and the like.

The method for generating the detailed information of the broadcasting programs corresponding the representative screens will be described as follows.

Firstly, the TP decoder 121 shown in FIG. 3 divides the data stream included in the TP stream with the video and audio streams by parsing, and outputs the data stream by decoding. Here, the data stream includes the detailed information about the broadcasting program.

Then, the decoded data stream is implemented in the story board 150 together with the images of the decompressed representative screen in the image decoder 133.

The user selects the representative screen of the broadcasting program which was recorded in the implemented story board using a wireless terminal such as a remote controller, and the selected signal is inputted to the control unit 110 of the PVR. Therefore, the control unit 110 applies the control signal to the storage unit 140 and transports the TP stream of the broadcasting program which is linked with the representative screen to the TP decoder 121.

The TP decoder 220 separates the TP stream into the video and audio streams by receiving the TP stream which was transported in the storage unit 140 and outputs the video and audio streams. Then, the video decoder 123 and the audio decoder 125 receive the separated video and audio streams, decodes the video and audio streams and outputs the video and audio signals to the displayer 50 and speaker 60 so that the user can watch the broadcasting program about the recorded representative screen.

The PVR in accordance with the present invention can perform real time recording and reservation recording of the on-air program, and accordingly the user can conveniently watch the recorded program in the format of the story board in which the representation screen and detailed information are included.

Also, since the viewer can watch the representative screen of the program as well as the subjects when watching the list of the recorded programs, in case there are many recorded programs, the user can access to the program which the user wants to watch by searching with a scroll bar by forming the scroll bar on the screen.

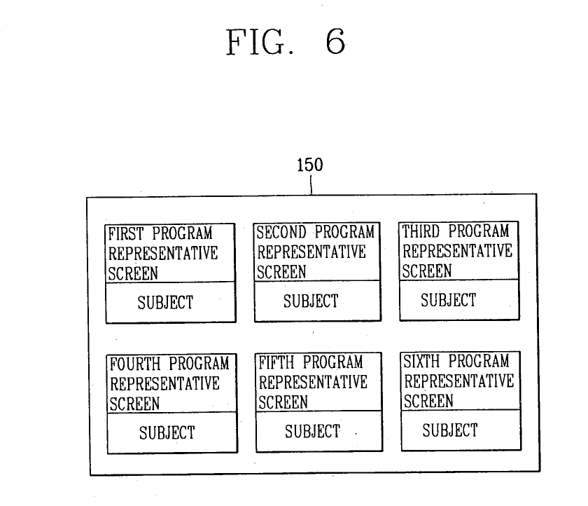

FIG. 6 is an exemplary view showing the story board in which the representative screen and detailed information of a plurality of broadcasting programs are included in accordance with the present invention.

As shown in FIG. 6, in the story board 150, there are representative screens of the first to sixth programs which are a plurality of broadcasting program that were completely recorded, and in the lower portion of the representative screens of the first to sixth programs, the subjects of the plurality of broadcasting programs are included. Therefore, the viewer can selectively watch the representative screen of the broadcasting program that the viewer wants to regenerate among the representative screens of the plurality of broadcasting programs displayed in the story board.

Also, when the user selects a representative screen of a specific broadcasting program in the story board of FIG. 6, it can be set to display the representative screens in unit of times of the specific broadcasting programs and the story board in which their detailed information is included.

The representative screens on the story board enables the users to guess the contents of the broadcasting program without watching the whole program, and to rapidly get to know the point to which the user previously watched in case the user watches the program to the center and watch the rest of the program later.

As described above, the present invention can implement the story board that includes the representative screen and detailed information of the already recorded broadcasting program, and enables the user to guess the list or contents of the broadcasting program without watching the whole program and regenerate programs by moving to a scene from which the user wants to watch in the program, so that the user can conveniently enjoy various functions of the PVR.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A personal video recorder, comprising:
a decoder unit for parsing a transport packet stream into a video stream and an audio stream by receiving the transport packet stream, decoding and outputting the parsed video stream and audio stream;
an image processing unit for capturing and outputting a representative image from the video signal which was decoded from the decoder unit; and
a storage unit for storing a transport packet stream which was not parsed but was bypassed in the decoder unit or storing a representative image outputted from the image processing unit.

2. The recorder, of claim 1, wherein the image processing unit includes:
an image encoder for generating a compressed image having formats of jpeg, gif and the like by receiving the decoded video signal; and
an image decoder for decompression by receiving the compressed image.

3. The recorder, of claim 1, wherein the decoder unit includes:
a transport packet decoder for parsing the transport packet stream of a broadcasting channel selected by a user into a video stream and an audio stream by receiving the transport packet stream;
an video decoder for outputting the video signal in a displayer by decoding after receiving the video stream which was parsed from the transport packet decoder; and
a audio decoder for outputting the audio signal in a speaker by decoding after receiving the audio stream which was parsed from the transport packet decoder.

4. The recorder, of claim 3, wherein the image processing unit includes:
an image encoder for capturing a representative image by receiving the decoded video signal which was outputted from the video decoder, and storing a compression image in the storage unit by encoding the representative image to a compression image; and
an image decoder for decompression by receiving the compression image stored in the storage unit, and outputting the decompressed image to the video decoder.

5. The recorder, of claim 1, wherein the representative image is linked to be mutually in gear with the transport packet stream which is stored in the storage unit.

6. The recorder, of claim 1, wherein the storage unit is a hard disk drive or a memory chip.

7. A method for operating a personal video, comprising:
storing a transport packet stream of the broadcasting channel selected by a user;
recording for generating and storing a representative image after decoding the transport packet stream; and
regenerating for outputting an video or a representative image by receiving the stored transport packet stream and the stored representative image.

8. The method of claim 7, wherein in the recording step, at least one representative image is generated and stored on the basis of the decoded video signal after parsing by receiving the transport packet stream and decoding by dividing the parsed stream into video and audio streams.

9. The method of claim 8, wherein in the recording step, the decoded video signal is received and is encoded into a compression image, and the encoded compression image is stored.

10. The method of claim 9, wherein in the regenerating step, the representative image is outputted by decompression of the stored compression image.

11. The method of claim 8, wherein the representative image is an image selected from video signals at a certain interval.

12. The method of claim 8, wherein the representative image is generated by an algorithm of selecting a representative image when changes of a scene, background and character is occurred from the video signal.

13. The method of claim 7, wherein in the regenerating step, the representative image is aligned in the display and is displayed in a format of a story board in which detailed information related with the representative images is included.

14. The method of claim 13, wherein the representative image is linked to be mutually in gear with the stored transmission packet stream.

15. The method of claim 14, wherein in case the user selects a specific representative image among the representative images in the displayed story board, the transport packet decoder receives the transport packet stream of a broadcasting program which is linked with the specific representative program which is stored in a storage unit, parses the stream into video and audio streams by applying the control signal to the storage unit, and outputs the video and audio of the broadcasting program through a displayer and a speaker by decoding the streams with the video and audio decoders.

16. A method for operating a personal video, comprising:
receiving transport packet streams of at least one broadcasting programs that a user selected to record;
parsing the input transport packet stream into video and audio streams or storing the transport packet stream which was not parsed;
generating at least one representative images corresponding to the broadcasting program by decoding the parsed video stream;
linking the stored transport packet stream to be mutually in gear with the respective representative images; and
aligning at least one representative images, and regenerating the story board in which the detailed information of the broadcasting program corresponding to the representative images is included.

17. The method of claim 16, wherein the image is generated by capturing a representative image among the decoded video signals.

18. The method of claim 16, wherein in case the user selects the representative image of the displayed story board, the transport packet stream which is linked with the representative image is divided into video and audio streams, video of the broadcasting program is displayed by decoding, and then audio is outputted.

19. The method of claim 16, wherein in the regenerating step, in case the user selects the representative screen of the displayed story board, representative images of the detailed broadcasting program were generated by further dividing the broadcasting program corresponding to the representative screen by times, and the story board in which the representative images of the detailed broadcasting program and the detailed information are included is displayed.

20. The method of claim 16, wherein the detailed information is contents of the broadcasting program corresponding to the representative screen or broadcasting time.
